(19) United States
(12) Patent Application Publication
(10) Pub. No.: US 2025/0082031 A1
(43) Pub. Date: Mar. 13, 2025

(54) AEROSOL-GENERATING DEVICE COMPRISING SUSCEPTOR ARRANGEMENT WITH LIQUID RETAINING ELEMENT

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 18/728,255

(22) PCT Filed: Jan. 13, 2023
(86) PCT No.: PCT/EP2023/050759

§ 371 Date: Jul. 11, 2024

(30) Foreign Application Priority Data
Jan. 20, 2022 (EP) 22152412.7

(51) Int. Cl. A24F 40/465; A24F 40/10; A24F 40/42; A24F 40/48; H05B 6/10

(52) U.S. Cl. CPC A24F 40/465; A24F 40/10; A24F 40/42; A24F 40/48; H05B 6/108

(57) ABSTRACT

An aerosol-generating device is provided, including: a susceptor arrangement including an inner airflow channel extending along a longitudinal center axis between a proximal end and a distal end of the susceptor arrangement, a tubular liquid-retaining element coaxially circumscribing at least a portion of the inner airflow channel, and an outer tubular susceptor element coaxially circumscribing the inner airflow channel and the tubular liquid-retaining element, at least a portion of a wall of the outer tubular susceptor element including a fluid-permeable material; and the device further including an air inlet in fluid connection with the inner airflow channel of the susceptor arrangement. An aerosol-generating system including the aerosol-generating device and a tubular cartridge is also provided.

The present disclosure relates to an aerosol-generating device comprising a susceptor arrangement. The present disclosure further relates to an aerosol-generating system.

It is known to provide an aerosol-generating device for generating an inhalable vapor. Such devices may heat an aerosol-forming substrate contained in a cartridge without burning the aerosol-forming substrate. The aerosol-generating device may comprise a heating arrangement. The heating arrangement may be an induction heating arrangement and may comprise an induction coil and a susceptor. The susceptor may be part of the device or may be part of the cartridge.

Upon heating to a target temperature, the aerosol-forming substrate vaporises to form an aerosol. The aerosol-forming substrate may be present in solid form or in liquid form. Liquid aerosol-forming substrate may be comprised in a liquid storage portion and may be delivered to the heating element via a capillary component. The liquid storage portion may form part of a replaceable or refillable cartridge.

It would be desirable to provide an aerosol-generating device which may reduce or avoid leakage of aerosol-forming substrate. It would be desirable to provide an aerosol-generating device which may reduce or avoid formation of liquid-droplets by condensation of vaporized components at walls of an airflow channel. It would be desirable to provide an aerosol-generating device which may reduce or avoid dragging of liquid-droplets, which may be present at walls of an airflow channel, towards a mouth-end of the device by the puff of a user. It would be desirable to provide an aerosol-generating device which may improve the user experience. It would be desirable to provide an aerosol-generating device with improved performance.

According to an embodiment of the invention there is provided an aerosol-generating device comprising a susceptor arrangement. The susceptor arrangement may comprise an inner airflow channel. The inner airflow channel may extend along a longitudinal center axis between a proximal end and a distal end of the susceptor arrangement. The susceptor arrangement may comprise a tubular liquid-retaining element coaxially circumscribing at least a portion of the inner airflow channel. The susceptor arrangement may comprise an outer tubular susceptor element coaxially circumscribing the inner airflow channel and the liquid-retaining element. At least a portion of a wall of the tubular susceptor element may comprise a fluid permeable material.

According to an embodiment of the invention there is provided an aerosol-generating device comprising a susceptor arrangement. The susceptor arrangement comprises an inner airflow channel extending along a longitudinal center axis between a proximal end and a distal end of the susceptor arrangement. The susceptor arrangement comprises a tubular liquid-retaining element coaxially circumscribing at least a portion of the inner airflow channel. The susceptor arrangement comprises an outer tubular susceptor element coaxially circumscribing the inner airflow channel and the liquid-retaining element. At least a portion of a wall of the tubular susceptor element comprises a fluid permeable material.

By the susceptor arrangement, an aerosol-generating device which reduces or avoids leakage of aerosol-forming substrate may be provided. By the susceptor arrangement, an aerosol-generating device which reduces or avoids formation of liquid-droplets by condensation of vaporized components at walls of an airflow channel may be provided. By the susceptor arrangement, an aerosol-generating device may be provided which reduces or avoids dragging of liquid-droplets, which may be present at walls of an airflow channel, towards a mouth-end of the device by the puff of a user. By the susceptor arrangement, an aerosol-generating device which may improve the user experience may be provided. By the susceptor arrangement, an aerosol-generating device with improved performance may be provided.

The liquid retaining element may absorb liquid droplets within the inner air flow channel. The liquid retaining element may be heated by thermal transfer from the susceptor element. Liquid absorbed by the liquid retaining element may thus be heated to vaporize and may contribute to the overall aerosolization.

The tubular susceptor element may comprise a proximal end region, a fluid permeable intermediate region and a distal region. One or both of the proximal end region a and the distal region may be fluid impermeable.

The tubular susceptor element may be longer than the tubular liquid-retaining element.

A portion of the inner surface of the longer tubular susceptor element may be covered by the tubular liquid-retaining element and a portion of the inner surface of the longer tubular susceptor element may be uncovered. Liquid aerosol-forming substrate may evaporate from the uncovered inner surface of the susceptor element towards the inner airflow channel. Additional design possibilities to adjust the aerosol formation may be provided.

A proximal end of the tubular liquid-retaining element may be located at a position within the intermediate region of the tubular susceptor element. The tubular liquid-retaining element may be arranged within the tubular susceptor element to extend from the distal region to a position within the intermediate region of the tubular susceptor element.

An inner diameter of the fluid permeable intermediate region may exceed an inner diameter of one or both of the distal region and the proximal end region. The inner diameters of the distal region and the proximal end region may be substantially identical.

By a larger inner diameter in the fluid permeable intermediate region, an evaporation chamber may be provided in the inner airflow channel at the position of the fluid permeable intermediate region of the tubular susceptor element.

The susceptor arrangement may comprise one or more sealing members. The one or more sealing members may be arranged to coaxially circumscribe the tubular susceptor element.

The susceptor arrangement may comprise one or both of a sealing member circumscribing the proximal end region of the susceptor element, and a sealing member circumscribing the distal region, preferably a proximal end of the distal region, of the susceptor element.

The sealing member may be a sealing ring, preferably an O-ring. The sealing member may comprise an elastomer. The elastomer may be one or more of as PTFE, Nitrile, Neoprene, EPDM Rubber, and Fluorocarbon.

One or both of the liquid-retaining element may comprise a porous material and the susceptor element may comprise a porous material. The porosity of one or both of the susceptor element and the liquid-retaining element may be between 25% and 80%, preferably between 55% and 75%, more preferably between 65% and 75%.

The porosity of the porous material of the susceptor element may be higher than the porosity of the porous material of the liquid-retaining element. Better aerosolization results may be provided when the porosity of the porous material of the susceptor element is higher than the porosity of the porous material of the liquid-retaining element. The porosity of the liquid-retaining element may be between 10% and 60%, preferably between 35% and 55%, more preferably between 40% and 50%, and may be lower than the porosity of the susceptor element.

As used herein, the term ‘porosity’ is defined as the percentage of a unit volume which is void of material. The porosity may be derived using standard method and equation giving a decimal value for porosity. Knowing the pore volume of a defined volume of material (Vp) and its total volume (Vt), porosity (Pt) is given by the ratio Vp/Vt. To express porosity as a percent, that decimal is simply multiplied by 100%. For example, Pt=0.51, therefore 0.51×100%=51%.

The susceptor element may comprise a high retention material. The liquid-retaining element may comprise a high retention material. The high retention material may be selected from one or both of a fiber-based high retention material and a ceramic-based high retention material. The high retention material may comprise one or more of porous silica ceramics, paper, paper like material, and non-woven carbon fiber.

The tubular liquid-retaining element may comprise a first tubular layer coaxially circumscribed by a second tubular layer. A thickness of a wall of the first tubular layer may be between 0.1 millimeter and 0.3 millimeter. A thickness of a wall of the second tubular layer may be between 0.3 millimeter and 3 millimeters.

The first tubular layer may comprise a fiber-based high retention material and the second tubular layer may comprise a ceramic-based high retention material. The first tubular layer may comprise a ceramic-based high retention material and the second tubular layer may comprise a fiber-based high retention material.

A length of the tubular susceptor element may be between 6 millimeters and 12 millimeters, preferably between 8 millimeters and 10 millimeters. An outer diameter of the tubular susceptor element may be between 1 millimeter and 6 millimeters, preferably between 2 millimeters and 4 millimeters.

A length of the tubular liquid-retaining element may be between 3 millimeters and 9 millimeters, preferably between 5 millimeters and 7 millimeters. An outer diameter of the tubular liquid-retaining element may be between 1 millimeter and 4 millimeters, preferably between 1 millimeter and 3 millimeters. An inner diameter of the tubular liquid-retaining element may be between 0.2 millimeter and 0.8 millimeter, preferably between 0.3 millimeter and 0.5 millimeter.

The aerosol-generating device may comprise an inductor coil coaxially circumscribing the susceptor arrangement. The inductor coil may be arranged for inductively heating the susceptor element of the susceptor arrangement.

The aerosol-generating device may be adapted for engaging with a cartridge, the cartridge comprising an aerosol-forming substrate. The aerosol-generating device may be adapted for receiving a cartridge, the cartridge comprising an aerosol-forming substrate. The cartridge may be replaceable.

The aerosol-generating device may comprise a tubular cavity coaxially circumscribing the susceptor arrangement. The tubular cavity may be arranged for insertion of a tubular cartridge into the cavity. The inductor coil may coaxially circumscribe the tubular cavity. The tubular cavity may extend coaxially between the susceptor arrangement and the inductor coil and may be arranged for insertion of a tubular cartridge into the cavity.

The aerosol-generating device may comprise an air inlet in fluid connection with the inner airflow channel of the susceptor arrangement.

According to an embodiment of the invention there is provided an aerosol-generating system, comprising an aerosol-generating device as described herein. The aerosol-generating system comprises a tubular cartridge comprising an aerosol-forming substrate circumscribing an inner hollow channel. The aerosol-generating system is arranged such that the inner hollow channel of the cartridge coaxially circumscribes at least a portion of the susceptor arrangement of the aerosol-generating device when the cartridge is connected to the aerosol-generating device.

It may be that the cartridge does not comprise the susceptor arrangement. It may be that the cartridge does not comprise a susceptor element. It may be that the cartridge does not comprise a susceptor material.

The cartridge may be releasably attachable to the aerosol-generating device. The cartridge may be refillable.

An inner wall of the tubular cartridge may comprise a fluid permeable opening. The fluid permeable opening may be sealed by a sealing member before use. The sealing member may be removable.

The sealing member may be a sliding-and-sealing member. The sliding-and-sealing member may be arranged to be slid longitudinally along the hollow channel of the cartridge when the susceptor arrangement is inserted into the hollow interior of the tubular cartridge.

The cartridge may comprise a mouthpiece at a proximal end thereof.

According to an embodiment of the invention there is provided a susceptor arrangement as described herein for an aerosol generating device.

According to an embodiment of the invention there is provided a cartridge as described herein for use with an aerosol generating device.

At least a portion of a wall of the tubular susceptor element may be fluid permeable. The susceptor element may comprise a porous material. The fluid permeable wall of the susceptor element may be made of a porous material. The fluid permeable wall of the susceptor element may comprise perforations. The fluid permeable wall of the susceptor element may be made of a non-porous material and comprise perforations.

The susceptor element may comprise a carbon-based material. The susceptor element may comprise a porous carbon-based material. The porous carbon-based material may comprise magnetic graphene. The porous carbon-based material may comprise magnetic carbon-based materials, for example one or more of irradiated graphite, nanocarbons, fullerenes, oxygen-containing carbons and graphene with point defects. The porous carbon-based material may comprise one or more carbon-based compounds with metal structural dispersion, for example a Fe₃O₄-graphitized carbon black (mGCB) composite which can be used to produce porous sheets, perforated, or compacted granulated structures to obtain the desired porosity.

The susceptor element may comprise one or both of a metal and an alloy. The susceptor element may comprise a ferromagnetic alloy material. The ferromagnetic alloy material may be perforated to provide a desired porosity. The alloy material may be ferromagnetic inox alloy.

The susceptor element may comprise at least one ferromagnetic stainless steel alloy. The susceptor element may comprise 304 stainless steel. The susceptor element may comprise one or more ferritic stainless steel alloys, for example those which are ferromagnetic and are used as magnetic components such as solenoid cores, pole pieces and return paths. The susceptor element may comprise a 410 stainless steel alloy.

The liquid-retaining element may comprise cotton. The liquid-retaining element may be made of cotton.

The liquid-retaining element may be a porous element. The liquid-retaining element may be capable of absorbing liquid aerosol-forming substrate. The liquid-retaining element may comprise a capillary material. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid from the distal part of the liquid-retaining element to the proximal part of the liquid-retaining element. Alternatively, the capillary material may comprise sponge-like or foam-like material. The structure of the capillary material may form a plurality of small bores or tubes, through which the liquid can be transported by capillary action. The capillary material may comprise any suitable material or combination of materials. Examples of suitable materials are a sponge or foam material, ceramic- or graphite-based materials in the form of fibres or sintered powders, foamed metal or plastics materials, a fibrous material, for example made of spun or extruded fibres, such as cellulose acetate, polyester, or bonded polyolefin, polyethylene, ethylene or polypropylene fibres, nylon fibres or ceramic. The capillary material may have any suitable capillarity and porosity so as to be used with different liquid physical properties. The liquid has physical properties, including but not limited to viscosity, surface tension, density, thermal conductivity, boiling point and vapour pressure, which allow the liquid to be transported through the capillary material by capillary action. The capillary material may be configured to convey the aerosol-forming substrate to the proximal part of the liquid-retaining element and to the susceptor element. The capillary material may extend into interstices in the susceptor element.

As used herein, the term ‘aerosol-forming substrate’ relates to a substrate capable of releasing volatile compounds that can form an aerosol or a vapor. Such volatile compounds may be released by heating the aerosol-forming substrate. The aerosol-forming substrate may be in liquid form. The terms ‘aerosol’ and ‘vapor’ are used synonymously.

The aerosol-forming substrate may be part of a cartridge. The aerosol-forming substrate may be part of the liquid held in the liquid storage portion of the cartridge. The liquid storage portion may contain a liquid aerosol-forming substrate.

Preferably, a liquid nicotine or flavor/flavorant containing aerosol-forming substrate may be employed in the liquid storage portion of the cartridge.

The aerosol-forming substrate may comprise nicotine.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the device. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol. Preferably, the aerosol former is glycerine.

As used herein, the term ‘cartridge’ refers to an article comprising an aerosol-forming substrate that is capable of releasing volatile compounds that can form an aerosol. For example, a cartridge may be an article that generates an aerosol that is directly inhalable by the user drawing or puffing on a mouthpiece at a proximal or user-end of the device or at a mouthpiece of the cartridge itself. A cartridge may be disposable. A cartridge may be reusable. A cartridge may be refillable. The cartridge may be insertable into a cavity of the aerosol-generating device.

As used herein, the term ‘liquid storage portion’ refers to a storage portion comprising an aerosol-forming substrate that is capable of releasing volatile compounds that can form an aerosol. The liquid storage portion may be configured as a container or a reservoir for storing the liquid aerosol-forming substrate.

The liquid storage portion may be configured as a replaceable tank or container. The liquid storage portion may be any suitable shape and size. For example, the liquid storage portion may be substantially cylindrical. The cross-section of the liquid storage portion may, for example, be substantially circular, elliptical, square or rectangular. The liquid storage portion may form part of the cartridge.

As used herein, the term ‘aerosol-generating device’ refers to a device that interacts with one or both of an aerosol-generating article and a cartridge to generate an aerosol.

As used herein, the term ‘aerosol-generating system’ refers to the combination of an aerosol-generating device with one or both of a cartridge and an aerosol-generating article. In the system, the aerosol-generating device and one or both of the aerosol-generating article and the cartridge cooperate to generate a respirable aerosol.

Preferably, the aerosol-generating device is portable. The aerosol-generating device may have a size comparable to a conventional cigar or cigarette. The device may be an electrically operated smoking device. The device may be a handheld aerosol-generating device. The aerosol-generating device may have a total length between 30 millimeters and 150 millimeters. The aerosol-generating device may have an external diameter between 5 millimeters and 30 millimeters.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

The housing may comprise at least one air inlet. The housing may comprise more than one air inlet.

The aerosol-generating device may comprise a heating element. The heating element may comprise at least one inductor coil for inductively heating one or more susceptors.

Operation of the heating element may be triggered by a puff detection system. Alternatively, the heating element may be triggered by pressing an on-off button, held for the duration of the user's puff. The puff detection system may be provided as a sensor, which may be configured as an airflow sensor to measure the airflow rate. The airflow rate is a parameter characterizing the amount of air that is drawn through the airflow path of the aerosol-generating device per time by the user. The initiation of the puff may be detected by the airflow sensor when the airflow exceeds a predetermined threshold. Initiation may also be detected upon a user activating a button. The sensor may also be configured as a pressure sensor.

The aerosol-generating device may include a user interface to activate the aerosol-generating device, for example a button to initiate heating of the aerosol-generating device or a display to indicate a state of the aerosol-generating device or of the aerosol-forming substrate.

The aerosol-generating device may include additional components, such as, for example a charging unit for recharging an on-board electric power supply in an electrically operated or electric aerosol-generating device.

As used herein, the term ‘proximal’ refers to a user-end, or mouth-end of the aerosol-generating device or system or a part or portion thereof, and the term ‘distal’ refers to the end opposite to the proximal end. When referring to the heating chamber, the term ‘proximal’ refers to the region closest to the open end of the cavity and the term ‘distal’ refers to the region closest to the closed end.

As used herein, the terms ‘upstream’ and ‘downstream’ are used to describe the relative positions of components, or portions of components, of the aerosol-generating device in relation to the direction in which a user draws on the aerosol-generating device during use thereof.

The term ‘airflow path’ as used herein denotes a channel suitable to transport gaseous media. An airflow path may be used to transport ambient air. An airflow path may be used to transport an aerosol. An airflow path may be used to transport a mixture of air and aerosol.

As used herein, a ‘susceptor’ or ‘susceptor element’ means an element that heats up when subjected to an alternating magnetic field. This may be the result of eddy currents induced in the susceptor element, hysteresis losses, or both eddy currents and hysteresis losses. During use, the susceptor element is located in thermal contact or close thermal proximity with an aerosol-forming substrate received in the aerosol-generating device or cartridge. In this manner, the aerosol-forming substrate is heated by the susceptor such that an aerosol is formed.

The susceptor material may be any material that can be inductively heated to a temperature sufficient to aerosolize an aerosol-forming substrate. The following examples and features concerning the susceptor may apply to one or both of the susceptor element of the cartridge, a susceptor of an aerosol-generating device, and a susceptor of an aerosol-generating article. Suitable materials for the susceptor material include graphite, molybdenum, silicon carbide, stainless steels, niobium, aluminium, nickel, nickel containing compounds, titanium, and composites of metallic materials. Preferred susceptor materials comprise a metal or carbon. Advantageously the susceptor material may comprise or consists of a ferromagnetic or ferri-magnetic material, for example, ferritic iron, a ferromagnetic alloy, such as ferromagnetic steel or stainless steel, ferromagnetic particles, and ferrite. A suitable susceptor material may be, or comprise, aluminium. The susceptor material may comprise more than 5 percent, preferably more than 20 percent, more preferably more than 50 percent, or more than 90 percent of ferromagnetic, ferri-magnetic or paramagnetic materials. Preferred susceptor materials may be heated to a temperature in excess of 250 degrees Celsius without degradation.

The susceptor material may be formed from a single material layer. The single material layer may be a steel layer.

The susceptor material may comprise a non-metallic core with a metal layer disposed on the non-metallic core. For example, the susceptor material may comprise metallic tracks formed on an outer surface of a ceramic core or substrate.

The susceptor material may be formed from a layer of austenitic steel. One or more layers of stainless steel may be arranged on the layer of austenitic steel. For example, the susceptor material may be formed from a layer of austenitic steel having a layer of stainless steel on each of its upper and lower surfaces. The susceptor element may comprise a single susceptor material. The susceptor element may comprise a first susceptor material and a second susceptor material. The first susceptor material may be disposed in intimate physical contact with the second susceptor material. The first and second susceptor materials may be in intimate contact to form a unitary susceptor. In certain embodiments, the first susceptor material is stainless steel and the second susceptor material is nickel. The susceptor element may have a two-layer construction. The susceptor element may be formed from a stainless steel layer and a nickel layer.

Intimate contact between the first susceptor material and the second susceptor material may be made by any suitable means. For example, the second susceptor material may be plated, deposited, coated, clad or welded onto the first susceptor material. Preferred methods include electroplating, galvanic plating and cladding.

The aerosol-generating device may comprise a power supply for powering the heating element. The power supply may comprise a battery. The power supply may be a lithium-ion battery. Alternatively, the power supply may be a nickel-metal hydride battery, a nickel cadmium battery, or a lithium-based battery, for example a lithium-cobalt, a lithium-iron-phosphate, lithium titanate or a lithium-polymer battery. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

The power supply may be a direct current (DC) power supply. In one embodiment, the power supply is a DC power supply having a DC supply voltage in the range of 2.5 Volts to 4.5 Volts and a DC supply current in the range of 1 Amp to 10 Amps (corresponding to a DC power supply in the range of 2.5 Watts to 45 Watts). The aerosol-generating device may advantageously comprise a direct current to alternating current (DC/AC) inverter for converting a DC current supplied by the DC power supply to an alternating current. The DC/AC converter may comprise a Class-D, Class-C or Class-E power amplifier. The AC power output of the DC/AC converter is supplied to the induction coil.

The power supply may be adapted to power an inductor coil and may be configured to operate at high frequency. A Class-E power amplifier is preferable for operating at high frequency. As used herein, the term ‘high frequency oscillating current’ means an oscillating current having a frequency of between 500 kilohertz and 30 megahertz. The high frequency oscillating current may have a frequency of from 1 megahertz to 30 megahertz, preferably from 1 megahertz to 10 megahertz, and more preferably from 5 megahertz to 8 megahertz.

In another embodiment the switching frequency of the power amplifier may be in the lower kHz range, e.g. between 100 kHz and 400 KHz. In the embodiments, where a Class-D or Class-C power amplifier is used, switching frequencies in the lower kHz range are particularly advantageous.

The aerosol-generating device may comprise a controller. The controller may be electrically connected to the inductor coil. The controller may be electrically connected to the first induction coil and to the second induction coil. The controller may be configured to control the electrical current supplied to the induction coil(s), and thus the magnetic field strength generated by the induction coil(s).

The power supply and the controller may be connected to the inductor coil(s).

The controller may be configured to be able to chop the current supply on the input side of the DC/AC converter. This way the power supplied to the inductor coil(s) may be controlled by conventional methods of duty-cycle management.

Below, there is provided a non-exhaustive list of non-limiting examples. Any one or more of the features of these examples may be combined with any one or more features of another example, embodiment, or aspect described herein.

Example E1: An aerosol-generating device comprising a susceptor arrangement, the susceptor arrangement comprising
an inner airflow channel extending along a longitudinal center axis between a proximal end and a distal end of the susceptor arrangement;
a tubular liquid-retaining element coaxially circumscribing at least a portion of the inner airflow channel; and
an outer tubular susceptor element coaxially circumscribing the inner airflow channel and the liquid-retaining element, wherein at least a portion of a wall of the tubular susceptor element comprises a fluid permeable material.

Example E2: The aerosol-generating device according to Example E1, wherein a length of the tubular susceptor element exceeds a length of the tubular liquid-retaining element.

Example E3: The aerosol-generating device according to Example E1 or Example E2, wherein the tubular susceptor element comprises a proximal end region, a fluid permeable intermediate region and a distal region.

Example E4: The aerosol-generating device according to Example E3, wherein a proximal end of the tubular liquid-retaining element is located at a position within the intermediate region of the tubular susceptor element.

Example E5: The aerosol-generating device according to Example E4, wherein the tubular liquid-retaining element is arranged within the tubular susceptor element to extend from the distal region to a position within the intermediate region of the tubular susceptor element.

Example E6: The aerosol-generating device according to any of Examples E3 to E5, wherein an inner diameter of the fluid permeable intermediate region exceeds an inner diameter of one or both of the distal region and the proximal end region, preferably, wherein the inner diameters of the distal region and the proximal end region are substantially identical.

Example E7: The aerosol-generating device according to any of Examples E3 to E6, wherein the susceptor arrangement comprises one or both of a sealing member circumscribing a proximal end of the distal region, and a sealing member circumscribing the proximal end region.

Example E8: The aerosol-generating device according to Example E7, wherein the sealing member is a sealing ring.

Example E9: The aerosol-generating device according to any of the preceding examples, wherein the liquid-retaining element comprises a porous material, and wherein the susceptor element comprises a porous material, preferably, wherein the porosity of the porous material of the susceptor element is higher than the porosity of the porous material of the liquid-retaining element.

Example E10: The aerosol-generating device according to any of the preceding examples, wherein the liquid-retaining element comprises a high retention material, preferably, wherein the high retention material is selected from one or both of a fiber-based high retention material and a ceramic-based high retention material.

Example E11: The aerosol-generating device according to any of the preceding examples, wherein the tubular liquid-retaining element comprises a first tubular layer coaxially circumscribed by a second tubular layer.

Example E12: The aerosol-generating device according to a combination of Examples E10 and E11, wherein the first tubular layer comprises a fiber-based high retention material and the second tubular layer comprises a ceramic-based high retention material, or vice versa.

Example E13: The aerosol-generating device according to any of the preceding examples, wherein a length of the tubular susceptor element is between 6 millimeters and 12 millimeters, preferably between 8 millimeters and 10 millimeters, and wherein an outer diameter of the tubular susceptor element is between 1 millimeter and 6 millimeters, preferably between 2 millimeters and 4 millimeters.

Example E14: The aerosol-generating device according to any of the preceding examples, comprising an inductor coil coaxially circumscribing the susceptor arrangement.

Example E15: The aerosol-generating device according to Example E14, comprising a tubular cavity extending coaxially between the susceptor arrangement and the inductor coil and being arranged for insertion of a tubular cartridge into the cavity.

Example E16: The aerosol-generating device according to any of the preceding examples, comprising an air inlet in fluid connection with the inner airflow channel of the susceptor arrangement.

Example E17: An aerosol-generating system, comprising
the aerosol-generating device according to any of the preceding examples; and
a tubular cartridge comprising an aerosol-forming substrate circumscribing an inner hollow channel, wherein the system is arranged such that the inner hollow channel of the cartridge coaxially circumscribes at least a portion of the susceptor arrangement when the cartridge is connected to the aerosol-generating device.

Example E18: The aerosol-generating system according to Example E17, wherein an inner wall of the tubular cartridge comprises a fluid permeable opening being sealed by a sealing member before use.

Example E19: The aerosol-generating system according to Example E18, wherein the sealing member is a sliding-and-sealing member, and wherein the sliding-and-sealing member is arranged to be slid longitudinally along the hollow channel of the cartridge when the susceptor arrangement is inserted into the hollow interior of the tubular cartridge.

Example E20: The aerosol-generating system according to any of Examples E17 to E19, wherein the cartridge comprises a mouthpiece at a proximal end thereof.

Features described in relation to one embodiment may equally be applied to other embodiments of the invention.

The invention will be further described, by way of example only, with reference to the accompanying drawings in which:

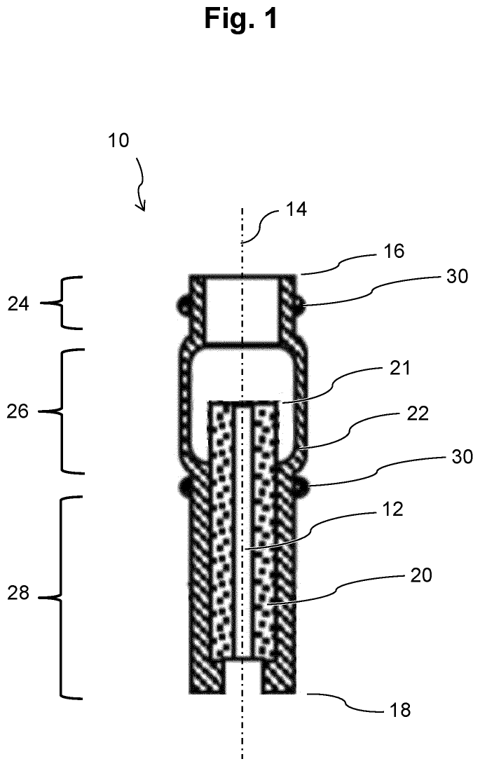

FIG. 1 shows a susceptor arrangement for an aerosol-generating device;

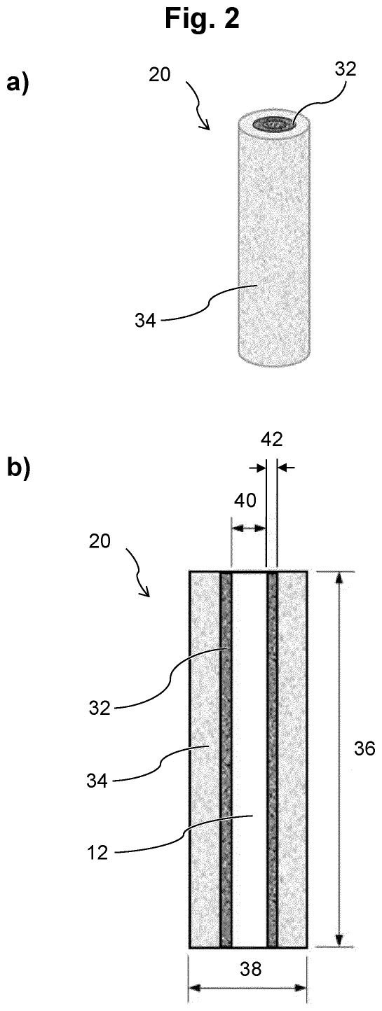

FIGS. 2a and 2b show a tubular liquid-retaining element 20;

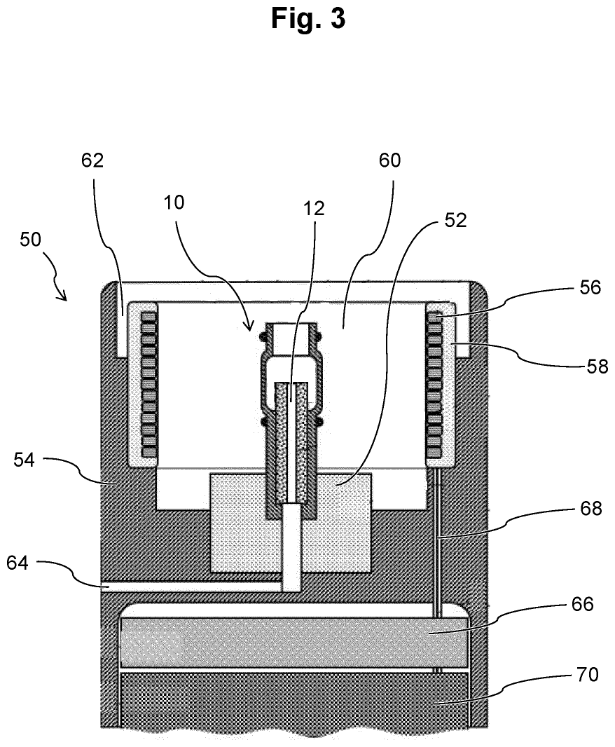

FIG. 3 shows an aerosol-generating device;

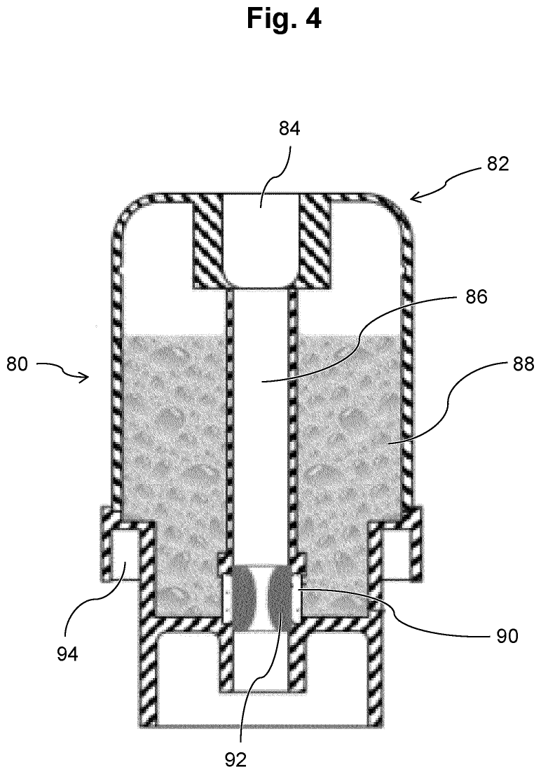

FIG. 4 shows a cartridge for use with an aerosol-generating device;

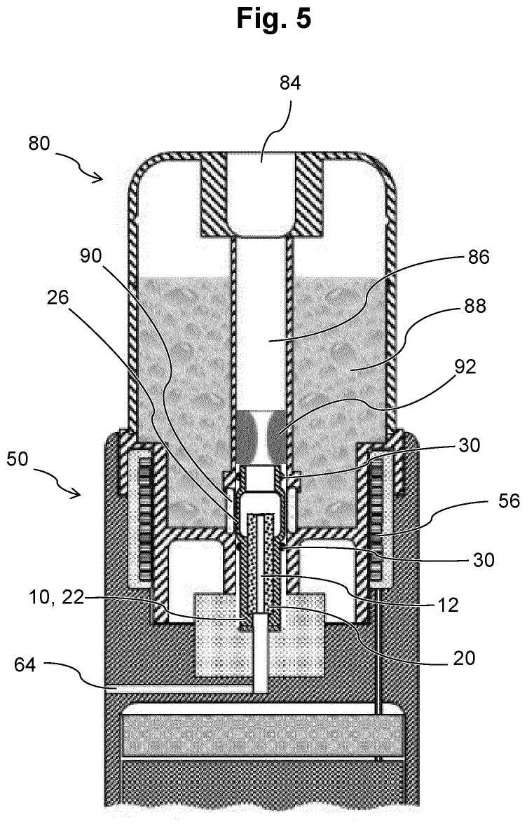

FIG. 5 shows an aerosol-generating system; and

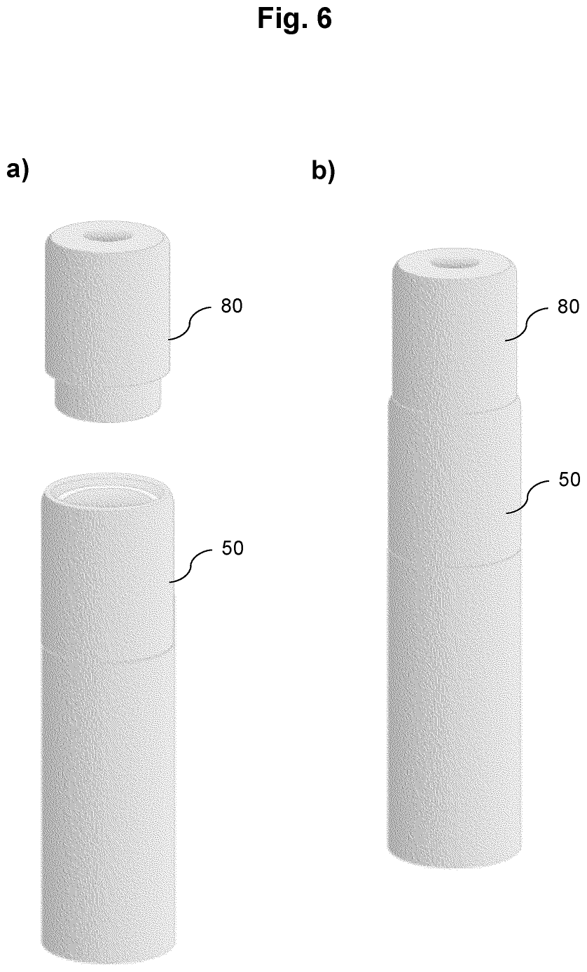

FIGS. 6a and 6b show an aerosol-generating system.

FIG. 1 shows a susceptor arrangement 10 for an aerosol-generating device in cross-sectional view.

The susceptor arrangement 10 comprises an inner airflow channel 12 extending along a longitudinal center axis 14 between a proximal end 16 and a distal end 18 of the susceptor arrangement 10. The susceptor arrangement 10 comprises a tubular liquid-retaining element 20 coaxially circumscribing a portion of the inner airflow channel 12. The susceptor arrangement 10 comprises an outer tubular susceptor element 22 coaxially circumscribing the inner airflow channel 12 and the liquid-retaining element 20. The tubular susceptor element 22 comprises a proximal end region 24, a fluid permeable intermediate region 26 and a distal region 28.

The length of the tubular susceptor element 22 exceeds the length of the tubular liquid-retaining element 20. The tubular liquid-retaining element 20 is arranged within the tubular susceptor element 22 to extend from the distal region 28 to a position within the intermediate region 26 of the tubular susceptor element 22. The proximal end 21 of the tubular liquid-retaining element 20 is located at a position within the intermediate region 26.

An inner diameter of the fluid permeable intermediate region 26 exceeds an inner diameter of both of the distal region 28 and the proximal end region 24. The inner diameters of the distal region 28 and the proximal end region 24 are substantially identical.

The susceptor arrangement 10 comprises a sealing member circumscribing a proximal end of the distal region 28 and a sealing member circumscribing the proximal end region 24. The sealing members are shaped as O-rings 30.

FIGS. 2a and 2b show a tubular liquid-retaining element 20 in perspective view (FIG. 2a) and in cross-sectional view (FIG. 2b). The tubular liquid-retaining element 20 of FIGS. 2a and 2b may be used as the tubular liquid-retaining element 20 in the susceptor arrangement 10 of FIG. 1. The tubular liquid-retaining element 20 comprises a first tubular layer 32 coaxially circumscribed by a second tubular layer 34. The first tubular layer 32 coaxially circumscribes the airflow channel 12.

A length 36 of the tubular liquid-retaining element 20 is between 3 millimeters and 9 millimeters, preferably between 5 millimeters and 7 millimeters. An outer diameter 38 of the tubular liquid-retaining element 20 is between 1 millimeter and 4 millimeters, preferably between 1 millimeter and 3 millimeters. An inner diameter 40 of the tubular liquid-retaining element 20 is between 0.2 millimeter and 0.8 millimeter, preferably between 0.3 millimeter and 0.5 millimeter. A thickness 42 of the first tubular layer 32 is between 0.1 millimeter and 0.3 millimeter.

FIG. 3 shows a subsection of an aerosol-generating device 50 in cross-sectional view. The aerosol-generating device 50 comprises the susceptor arrangement 10 of FIG. 1 mounted on a support element 52 within a housing 54 of the aerosol-generating device 50.

The aerosol-generating device 50 comprises an inductor coil 56 coaxially circumscribing the susceptor arrangement 10. The inductor coil 56 is housed within a casing 58.

The aerosol-generating device 50 comprises a tubular cavity 60 extending coaxially between the susceptor arrangement 10 and the inductor coil 56 and being arranged for insertion of a tubular cartridge into the cavity 60. The aerosol-generating device 50 further comprises an annular cartridge connecting port 62.

The aerosol-generating device 50 comprises an air inlet 64 in fluid connection with the inner airflow channel 12 of the susceptor arrangement 10.

The aerosol-generating device 50 further comprises a controller 66 in wired connection 68 with both the inductor coil 56 and a power supply 70, preferably a rechargeable battery. A distal part of the aerosol-generating device 50 comprising a distal portion of the power supply 70 is cut off and is not fully shown in FIG. 3. FIG. 3 thus shows a subsection of the aerosol-generating device 50.

FIG. 4 shows in cross-sectional view a tubular cartridge 80 for use with an aerosol-generating device 10, for example for use with the aerosol-generating device 10 of FIG. 3.

The cartridge 80 comprises a mouthpiece 82 at a proximal end thereof. The mouthpiece comprises an air outlet 84 in fluid connection with an inner hollow channel 86. The inner hollow channel 86 is coaxially circumscribed by a tubular liquid reservoir holding a liquid aerosol forming substrate 88. An inner wall of the tubular cartridge 80 comprises a fluid permeable opening 90. The fluid permeable opening 90 is sealed by a sealing member before use. The sealing member is a sliding-and-sealing member 92. The sliding-and-sealing member 92 is arranged to be slid longitudinally along the hollow channel 86 of the cartridge 80 when the susceptor arrangement 10 is inserted into the hollow interior of the tubular cartridge 90. The cartridge 80 further comprises an annular connecting port 94 for releasably connecting with the cartridge connecting port 62 of the aerosol-generating device 50.

FIG. 5 shows a cross-sectional view of an aerosol-generating system comprising the aerosol-generating device 50 of FIG. 3 and the cartridge 80 of FIG. 4 in an attached configuration.

The aerosol-generating system is arranged such that, in the attached configuration, the inner hollow channel 86 of the cartridge 80 coaxially circumscribes a proximal portion of the susceptor arrangement 10 of the aerosol-generating device 50. A continuous airflow path is established extending from the air inlet 64 via the airflow channel 12 and the inner hollow channel 86 to the air outlet 84.

On inserting the proximal portion of the susceptor arrangement 10 into the hollow channel 86, the sliding-and-sealing member 92 has been slid longitudinally along the hollow channel 86 in a direction towards the proximal end of the cartridge 80. Therefore, the sliding-and-sealing member 92 is no longer covering and sealing the fluid permeable opening 90. The fluid permeable intermediate region 26 of the tubular susceptor element 22 of the susceptor arrangement 10 coincides with the fluid permeable opening 90. The fluid permeable opening 90 coaxially circumscribes the fluid permeable intermediate region 26. Consequently, a liquid aerosol-forming substrate 88 may migrate from the liquid-storage portion towards and into the fluid permeable intermediate region 26. The O-rings 30 may prevent the liquid aerosol-forming substrate 88 from an uncontrolled migration into the airflow path at positions proximal or distal to the fluid permeable intermediate region 26.

During use, an alternating current applied to the inductor coil 56 induces electric currents in the tubular susceptor element 22. As a consequence, the tubular susceptor element 22 heats up. Heat is distributed to the liquid aerosol-forming substrate 88 within, or in close proximity to the fluid permeable intermediate region 26 which, in turn evaporates. Ambient air entering via air inlet 64 may take up the evaporated substrate which may further condense to form an aerosol on the way towards the air outlet 84, where the aerosol may be inhaled by a user.

Liquid droplets of aerosol-forming substrate 88 which have been inadvertently condensed within the airflow path may be taken up the tubular liquid-retaining element 20. The tubular liquid-retaining element 20 may heat up by means of thermal transfer from the tubular susceptor element 22. Thereby, inadvertently condensed aerosol-forming substrate 88 which has been taken up by the liquid-retaining element 20 may eventually be evaporated and participate in aerosol-formation.

FIGS. 6a and 6b show an aerosol-generating system in perspective views. The cartridge 80 is releasably attachable to the aerosol-generating device 50. The cartridge 80 may be the cartridge 80 of the embodiment of FIG. 4. The aerosol-generating device 50 may be the aerosol-generating device 50 of the embodiment of FIG. 3. FIG. 6a shows the cartridge 80 and the aerosol-generating device 50 in a detached configuration. FIG. 6b shows the attached configuration where the cartridge 80 is connected to the aerosol-generating device 50.

1.-14. (canceled)

15. An aerosol-generating device, comprising:
a susceptor arrangement comprising:
an inner airflow channel extending along a longitudinal center axis between a proximal end and a distal end of the susceptor arrangement,
a tubular liquid-retaining element coaxially circumscribing at least a portion of the inner airflow channel, and
an outer tubular susceptor element coaxially circumscribing the inner airflow channel and the tubular liquid-retaining element,
wherein at least a portion of a wall of the outer tubular susceptor element comprises a fluid-permeable material; and
an air inlet in fluid connection with the inner airflow channel of the susceptor arrangement.

16. The aerosol-generating device according to claim 15, wherein a length of the outer tubular susceptor element exceeds a length of the tubular liquid-retaining element.

17. The aerosol-generating device according to claim 15, wherein the outer tubular susceptor element comprises a proximal end region, a fluid-permeable intermediate region, and a distal region.

18. The aerosol-generating device according to claim 17, wherein a proximal end of the tubular liquid-retaining element is located at a position within the intermediate region of the outer tubular susceptor element.

19. The aerosol-generating device according to claim 18, wherein the tubular liquid-retaining element is arranged within the outer tubular susceptor element to extend from the distal region to a position within the intermediate region of the outer tubular susceptor element.

20. The aerosol-generating device according to claim 17, wherein an inner diameter of the fluid-permeable intermediate region exceeds an inner diameter of one or both of the distal region and the proximal end region.

21. The aerosol-generating device according to claim 20, wherein the inner diameters of the distal region and the proximal end region are substantially identical.

22. The aerosol-generating device according to claim 17, wherein the susceptor arrangement further comprises one or both of a sealing member circumscribing a proximal end of the distal region, and a sealing member circumscribing the proximal end region.

23. The aerosol-generating device according to claim 15,
wherein the tubular liquid-retaining element comprises a porous material, and
wherein the susceptor element further comprises a porous material.

24. The aerosol-generating device according to claim 23, wherein a porosity of the porous material of the susceptor element is higher than a porosity of the porous material of the tubular liquid-retaining element.

25. The aerosol-generating device according to claim 15, wherein the tubular liquid-retaining element comprises a high retention material.

26. The aerosol-generating device according to claim 25, wherein the high retention material is selected from one or both of a fiber-based high retention material and a ceramic-based high retention material.

27. The aerosol-generating device according to claim 15, wherein the tubular liquid-retaining element comprises a first tubular layer coaxially circumscribed by a second tubular layer.

28. The aerosol-generating device according to claim 27, wherein the first tubular layer comprises a fiber-based high retention material and the second tubular layer comprises a ceramic-based high retention material, or vice versa.

29. The aerosol-generating device according to claim 15,
wherein a length of the outer tubular susceptor element is between 6 millimeters and 12 millimeters, and
wherein an outer diameter of the outer tubular susceptor element is between 1 millimeter and 6 millimeters.

30. The aerosol-generating device according to claim 15,
wherein a length of the outer tubular susceptor element is between 8 millimeters and 10 millimeters, and
wherein an outer diameter of the outer tubular susceptor element is between 2 millimeters and 4 millimeters.

31. The aerosol-generating device according to claim 15, further comprising:
an inductor coil coaxially circumscribing the susceptor arrangement; and
a tubular cavity extending coaxially between the susceptor arrangement and the inductor coil and being arranged for insertion of a tubular cartridge into the tubular cavity.

32. An aerosol-generating system, comprising:
the aerosol-generating device according to claim 15; and
a tubular cartridge comprising an aerosol-forming substrate circumscribing an inner hollow channel,
wherein the aerosol-generating system is arranged such that the inner hollow channel of the tubular cartridge coaxially circumscribes at least a portion of the susceptor arrangement when the tubular cartridge is connected to the aerosol-generating device.

33. The aerosol-generating system according to claim 32, wherein an inner wall of the tubular cartridge comprises a fluid-permeable opening being sealed by a sealing member before use.

34. The aerosol-generating system according to claim 33, wherein the sealing member is a sliding-and-sealing member arranged to be slid longitudinally along the inner hollow channel of the cartridge when the susceptor arrangement is inserted into the hollow interior of the tubular cartridge.
